(19) United States
(12) Patent Application Publication
(10) Pub. No.: US 2009/0049500 A1
(43) Pub. Date: Feb. 19, 2009

(54) RECEIVING DEVICE

(76) Inventors: Hiroshi AOKI, Hiroshima (JP); Tsuneki Yasuho, Osaka (JP); Yasunobu Kanzaki, Hyogo (JP); Keisuke Iwata, Osaka (JP); Tsuyoshi Ide, Osaka (JP); Tatsuto Horibe, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/183,362

(22) Filed: Jul. 31, 2008

(30) Foreign Application Priority Data
Aug. 1, 2007 (JP) 2007-200486
Aug. 8, 2007 (JP) 2007-206545

(51) Int. Cl. H04N 7/16; H04N 7/173

(52) U.S. Cl. 725/131; 725/146

(57) ABSTRACT

A receiving device is one capable of processing a first application received from a broadcast station and a previously built-in second application, including: a first application management unit operable to control the first application; a second application management unit operable to control the second application; an operation management unit operable to hold operating states of the first application and the second application; and a duplicate function management unit operable to hold exclusion/sharing information showing priorities of the first application and the second application, and operable to make the first application management unit or the second application management unit perform an exclusion control based upon the exclusion/sharing information or the operating state managed by the operation management unit, in which the duplicate function management unit terminates the second application in activation, upon activation of the first application.

This application claims priority based upon Japanese Patent Application No. 2007-200486 filed in Japan on Aug. 1, 2007 and Japanese Patent Application No. 2007-206545 filed in Japan on Aug. 8, 2007, and the contents of these applications are incorporated herein by reference as forming part of the specification.

### BACKGROUND OF THE INVENTION

1. Field of the Invention

The present invention relates to a receiving device for cable broadcasting and the like, and particularly to a cable broadcast receiving device which realizes a variety of functions based upon a built-in application and a downloaded application. Further, the present invention relates to a receiving device capable of parallelly processing an application transmitted from a broadcast station with a downloaded application and a previously built-in application.

2. Description of the Related Art

Since its technical development has conventionally been advanced depending upon cable broadcast companies, cable broadcasting has been a closed market and has lost the opportunities for introduction of innovative technology, whereby its expansibility has been impaired.

Recently, digitalization has proceeded also in cable broadcasting, and a variety of services have been provided. As a receiving device for such cable broadcasting, a variety of techniques have been developed, as described in Japanese Patent Laid-open Publication No. 2006-511106.

Further, in order to allow adoption of the same technique regardless of different cable broadcast companies so as to promote free competition, standardization of a hardware application of each component constituting a reception terminal and software for operating the application in the reception terminal has been proposed. For example, as a standard for next-generation cable broadcasting for North America, Open Cable Application Platform (OCAP) has been proposed.

The biggest characteristic in this Open Cable Application Platform (OCAP) standard is downloading and executing an application multiplexed by broadcast waves, and thereby, a receiving device having downloaded the application becomes capable of realizing diversified services including an interactive data broadcasting service, as described in Japanese Patent Laid-open Publication No. 2005-73239.

According to OCAP, a cable broadcast receiving device such as TV or Set Top Box (STB) is capable of downloading, from a broadcast station, a variety of applications [Java® applications] such as an electric program guide (EPG) and an application for viewing Video On Demand (VOD). Further, the downloaded application (hereinafter referred to as OCAP application) is executed based upon Application Program Interface (API) which is defined by the OCAP standard, to realize a prescribed function.

The cable broadcast receiving device holds an application originally incorporated therein (hereinafter referred to as built-in application) other than the OCAP application transmitted from the cable broadcast station side. The cable broadcast receiving device executes a function in accordance with the built-in application in the case of not having the OCAP application.

### SUMMARY OF THE INVENTION

However, there has been a problem with the OCAP standard in that a specific process in the case of simultaneous operation of the OCAP application and the built-in application is not defined.

There has thus been a problem with the cable broadcast receiving device in terms of implementation in that a condition may occur where the OCAP application and the built-in application simultaneously realize the same function, thereby causing a user to be confused in operating the receiving device.

Further, there has also been a problem in terms of implementation in that, since a timing for version upgrade of the OCAP application is also not clearly defined in a condition where the built-in application is in operation, a condition may occur, for example where a version of the OCAP application currently in activation is immediately upgraded when a request for version upgrade of the OCAP application is made, thereby causing the user to be confused.

A first object of the present invention is to provide a receiving device capable of making an adjustment between control by a built-in application and control by an OCAP application, to prevent the user from being confused in operating the receiving device.

On the other hand, as described above, the biggest characteristic in the OCAP standard is downloading and executing an application multiplexed by broadcast waves. Thereby, the receiving device having downloaded the application becomes capable of realizing diversified services including the interactive data broadcasting service.

However, as described above, there has been a problem with the OCAP standard in that a specific process is not defined for the case of simultaneous operation of the OCAP application and the built-in application.

There has thus been a problem with the receiving device in terms of implementation in that a condition may occur where the OCAP application and the built-in application simultaneously realize the same function, thereby causing the user to be confused in operating the receiving device. Further, there has also been a problem in terms of implementation in that the OCAP application and the built-in application have an influence upon each other in resource control, thereby causing occurrence of a defect in operating the receiving device.

A second object of the present invention is to provide a receiving device which prevents defects of user's operationality and the resource control in a condition where the OCAP application and the built-in application can simultaneously realize the same function.

A receiving device according to a first mode of the present invention is a cable broadcast receiving device, capable of processing a first application received from a broadcast station and a previously built-in second application, and comprising: a first application management unit which controls the first application; a second application management unit which controls the second application; an operation management unit which holds operating states of the first application and the second application; and a duplicate function management unit which holds exclusion/sharing information showing priorities of the first application and the second application, and makes the first application management unit or the second application management unit perform an exclusion control based upon the exclusion/sharing information or the operating state managed by the operation management unit, the cable broadcast receiving device being wherein the duplicate function management unit terminates the second application in activation, upon activation of the first application.

Further, a receiving device according to a second mode of the present invention is a receiving device, capable of processing a first application received from a broadcast station and a previously built-in second application, and comprising: a first application management unit which controls the first application; a second application management unit which controls the second application; an operation management unit which holds operating states of the first application and the second application; and a duplicate function management unit which holds exclusion/sharing information showing priorities of the first application and the second application, and makes the first application management unit or the second application management unit perform an exclusion control based upon the exclusion/sharing information or the operating state managed by the operation management unit, the receiving device being wherein the first application prevents activation of a third application relevant to the first application based upon a result of the exclusion control by the duplicate function management unit.

Further, a receiving device according to a third mode of the present invention is wherein in the configuration of the receiving device according to the first mode, the first application transmits a prescribed inquiry request to the first application management unit upon activation, and the first application management unit acquires information on the prescribed inquiry request from the duplicate function management unit, and notifies the first application of the acquired information as a response to the prescribed inquiry request.

Further, a receiving device according to a fourth mode of the present invention is wherein in the configuration of the receiving device according to the second mode, the first application transmits a prescribed inquiry request to the first application management unit upon activation, and the first application management unit acquires information on the prescribed inquiry request from the duplicate function management unit, and notifies the first application of the acquired information as a response to the prescribed inquiry request.

Further, a receiving device according to a fifth mode of the present invention is wherein in the configuration of the receiving device according to the third mode, the first application activates a third application relevant to the first application upon receipt of the response to the prescribed inquiry request, and the third application makes a prescribed notification to the duplicate function management unit upon activation, and upon receipt of the prescribed notification, the duplicate function management unit makes the second application management unit terminate the second application.

Further, a receiving device according to a sixth mode of the present invention is wherein in the configuration of the receiving device according to the fourth mode, the first application prevents activation of a third application relevant to the first application upon receipt of the response to the prescribed inquiry request.

Further, a receiving device according to a seventh mode of the present invention is wherein in the configuration of the receiving device according to the firth or sixth mode, the second application and the third application are applications having the same function.

Further, a receiving device according to an eighth mode of the present invention is wherein in the configuration of the receiving device according to the seventh mode, the same function is a PIN input function.

Further, a receiving device according to a ninth mode of the present invention is wherein in the configuration of the receiving device according to the first mode, the second application is an application relevant to at least a banner display and a tuning error display.

Further, a receiving device according to a tenth mode of the present invention is a receiving device, capable of processing a first application received from a broadcast station and a previously built-in second application, and comprising: a cable card management unit which receives at least version information of the first application and a storage location of the first application; an application holding unit which holds the first application; a first application management unit which holds information of the first application in activation; a second application management unit which controls the second application, and also detects a standby-off state; and a version management unit which holds the version information of the first application held by the application holding unit, and also controls version upgrade of the first application, the receiving device being wherein the version management unit determines whether or not version upgrade is necessary based upon the version information acquired from the cable card management unit, the information of the first application in activation which was acquired from the first application management unit, and the held version information, and in the case of determining that version upgrade of the first application in activation is necessary, the version management unit makes the cable card management unit receive a latest first application from the storage location based upon a standby-off notification from the second application management unit, to rewrite the first application in the application holding unit to the latest first application.

Further, a receiving device according to an eleventh mode of the present invention is wherein in the configuration of the receiving device according to the tenth mode, the version management unit makes a rewriting completion notification to the first application management unit after rewriting the first application in the application holding unit to the latest first application, and the first application management unit is reactivated based upon the rewriting completion notification.

A receiving device according to the present invention is a receiving device, capable of processing a first application received from a broadcast station and a second application previously stored into the receiving device, and comprising: a first application management unit which controls the first application; a second application management unit which controls the second application; a data management unit which stores a setting information for setting outputs of an image or a sound of the first application management unit and the second application management unit; and an event input unit operable to input an event, the receiving device rewriting the setting information stored in the data management unit when the setting information stored in the data management unit is changed by the event input unit during activation of the first or second application.

According to this configuration, in the present invention, in the first application received from the broadcast station and the second application previously stored into the receiving device, the setting information for setting outputs of an image or a sound stored in the data management unit is rewritten when the setting information stored in the data management unit is changed by the event input unit during activation of both the first application and the second application, whereby the need for an individual change in setting information of each application is eliminated to improve user's operationality, and a resource of each application can be shared by the data management unit, so that a defect in resource control can be prevented.

Further, a receiving device according to the present invention is a receiving device, capable of processing a first application received from a broadcast station and a second application previously stored into the receiving device, and comprising: a first application management unit which controls the first application; a second application management unit which controls the second application; a data management unit which stores a setting information for setting outputs of an image or a sound of the first application management unit and the second application management unit; and an event input unit operable to input an event, the receiving device being wherein the first or second application in activation outputs an image or a sound based upon the setting information in the data management unit, in which the setting information has been changed, when the setting information stored in the data management unit is changed by the event input unit upon activation of either the first or second application.

According to this configuration, in the present invention, in the first application received from the broadcast station and the second application previously stored into the receiving device, the setting information for setting outputs of an image or a sound stored in the data management unit is rewritten when the setting information stored in the data management unit is changed by the event input unit during activation of either the first application or the second application, whereby the need for an individual change in setting information of each application is eliminated to improve user's operationality, and a resource of each application can be shared by the data management unit, so that a defect in resource control can be prevented.

Further, in addition to the above-mentioned contents, the present invention is a receiving device, in which the data management unit has a first region that stores a setting information accessed in common by the first application management unit and the second application management unit, and a second region that stores a setting information different between the first application management unit and the second application management unit, and which sets the setting information only in the whole or part of the first region and only in the whole or part of a region in the second region that stores the setting information of the application currently in activation to initial states when an event of setting the setting information of the application currently in activation to initial states is input by the event input unit.

According to this configuration, in the present invention, the setting information for setting outputs of an image or a sound stored in the data management unit is rewritten as described above, whereby the need for an individual change in setting information of each application is eliminated to improve user's operationality, and a resource of each application can be shared by the data management unit. Further, in addition to an effect that a defect in resource control can be prevented, the user's operationality can further be improved by providing a region where the setting information of the first and second applications are initialized in common and a region where the setting information in the respective applications are individually initialized when performing initialing process.

Further, the present invention is a receiving device, capable of processing a first application received from a broadcast station and a second application previously stored into the receiving device, and comprising: a first application management unit which controls the first application; a second application management unit which controls the second application; a duplicate management unit which manages interruption of the other application during operation of either the first or second application; an operation management unit which stores an operating state of the first or the second application; and an event input unit operable to input an event, the receiving device managing as to which, the first or second applications, is to be outputted and transmitting a result of the management to the operation management unit by the duplicate management unit when an event of starting a channel selection for a prescribed service at prescribed time in the first or second application is input by the event input unit.

According to this configuration, in the present invention, in a case where an event of starting a channel selection for a prescribed service at prescribed time in the other application not in operation is input by the event input unit during operation of either the first or second application, it is managed as to which, the first or second applications, is to be outputted so that competition of the first and second applications can be avoided.

According to the present invention, in the receiving device, an adjustment is made between the control by the built-in application and the control by the OCAP application, and it is thereby possible to prevent the user from being confused in operating the receiving device.

Further, according to the present invention, it is possible to efficiently perform version upgrade of the OCAP application.

In the present invention, in the first application received from the broadcast station and the second application previously stored into the receiving device, the setting information for setting outputs of an image or a sound stored in the data management unit is rewritten when the setting information stored in the data management unit is changed by the event input unit during activation of both the first application and the second application, whereby the need for an individual change in setting information of each application is eliminated to improve user's operationality. Further, a resource of each application can be shared by the data management unit so that a defect in resource control can be prevented.

Further, in the present invention, in the first application received from the broadcast station and the second application previously stored into the receiving device, the setting information for setting outputs of an image or a sound stored in the data management unit is rewritten when the setting information stored in the data management unit is changed by the event input unit during activation of either the first application or the second application, whereby the need for an individual change in setting information of each application is eliminated to improve user's operationality. Further, a resource of each application can be shared by the data management unit so that a defect in resource control can be prevented.

Further, in the present invention, the setting information for setting outputs of an image or a sound stored in the data management unit is rewritten as described above, whereby the need for an individual change in setting information of each application is eliminated to improve user's operationality, and a resource of each application can be shared by the data management unit. Further, in addition to an effect that a defect in resource control can be prevented, the user's operationality can further be improved by providing a region where the setting information of the first and second applications are initialized in common and a region where the setting information in the respective applications are individually initialized when performing initializing process.

Further, in the present invention, in a case where an event of starting a channel selection for a prescribed service at prescribed time in the other application not in operation is input by the event input unit during operation of either the first or second application, it is managed as to which, the first or second applications, is to be outputted so that competition of the first and second applications can be avoided.

### BRIEF DESCRIPTION OF THE DRAWINGS

A variety of objects, characteristics, and advantages of the present invention will be apparent from the preferred embodiments as will be explained hereunder with reference to the attached drawings:

FIG. 1 is a view showing a hardware configuration of a receiving device according to first embodiment of the present invention;

FIG. 2 is a view showing a functional configuration of the receiving device according to first embodiment of the present invention;

FIG. 3 is a view showing state transition of the receiving device according to first embodiment of the present invention;

FIG. 4 is a view showing a functional classification of the receiving device according to first embodiment of the present invention;

FIG. 5 is a view showing control of a PIN input screen according to first embodiment of the present invention;

FIG. 6 is a flowchart showing a process regarding exclusion control upon a PIN input according to first embodiment of the present invention;

FIG. 7 is a flowchart showing a process regarding upgrade of a version of XAIT according to second embodiment of the present invention;

FIG. 8 is a flowchart of data sharing in third embodiment of the present invention;

FIG. 9 is a flowchart of data sharing in third embodiment of the present invention;

FIG. 10 is an image constitutional view of third embodiment of the present invention

FIG. 11 is a flowchart of a reset process in fourth embodiment;

FIG. 12 is an image constitutional view of fourth embodiment of the present invention;

FIG. 13 is an image constitutional view of fourth embodiment of the present invention;

FIG. 14 is a constitutional view of a data control unit in fourth embodiment of the present invention; and

FIG. 15 is a flowchart of a Timer On process in fifth embodiment of the present invention.

### PREFERRED EMBODIMENT OF THE PRESENT INVENTION

In the following, a receiving device as the best mode for carrying out the present invention is described with reference to the attached drawings. It is to be noted that in the drawing, the same numeral is provided to the substantially the same materials.

### First Embodiment

### <Hardware Configuration of Receiving Device>

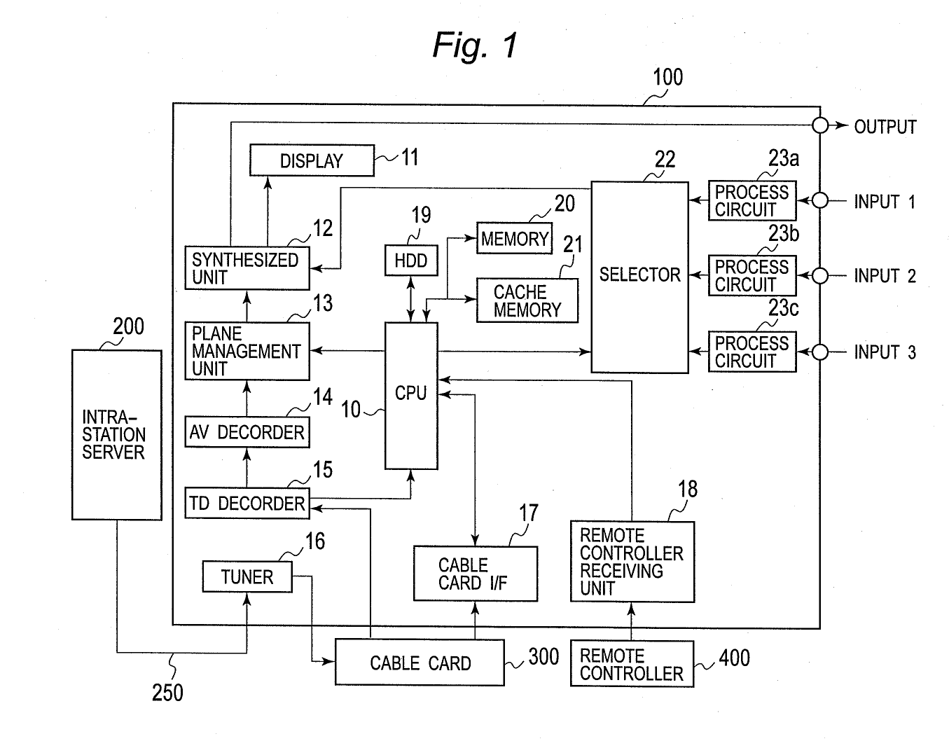

FIG. 1 is a view showing a hardware configuration of a receiving device 100 according to first embodiment of the present invention. This receiving device 100 functions as a cable broadcast receiving device. This receiving device 100 is connected with an intra-station server 200, which provides a cable broadcast set in a cable broadcast station, through a cable 250, and receives a cable broadcast by inserting a cable card 300 for receiving a cable broadcast from a specific cable broadcast station and performing a prescribed process. Further, the receiving device 100 receives user's operation information (key code) through a remote controller 400, and executes a process in accordance with the received key code. Moreover, the receiving device 100 has an output system (output) for outputting an image/sound signal to an external recording equipment of DVD or the like, and an input system (input 1, input 2, input 3) of a plurality of image/sound signals other than information from the cable broadcast. Here, the receiving device 100 of the present first embodiment is capable of receiving a cable broadcast compliant with the OCAP standard. It is to be noted that in FIG. 1, a configuration for processing a sound signal is omitted for the sake of simplicity of the description.

The receiving device 100 is configured of a CPU 10, a display 11, a synthesized unit 12, a plane management unit 13, an AV decoder 14, a TD decoder 15, a tuner 16, a cable card interface (cable card I/F) 17, a remote controller receiving unit 18, a hard disc drive (HDD) 19, a memory 20, a cache memory 21, a selector 22, and process circuits 23a to 23c.

The CPU 10 is a controller that controls an operation of the receiving device 100. The CPU 10 is connected with HDD 19 as a data storage unit, the volatile memory 20 and the cache memory 21 as a nonvolatile storage unit. Further, based upon a key code input from the remote controller receiving unit 18, a cable broadcast and any one of the inputs 1 to 3 are displayed on the display 11.

The display 11 displays an image outputted, or received, from the synthesized unit 12. The synthesized unit 12 synthesizes each of planes outputted from the plane management unit 13, and outputs planes to the display 11 or the external recording equipment. Here, in the case of outputting planes to the display 11, a built-in application dedicated plane, a video plane, a still plane, and an OSD plane are each synthesized in accordance with operating states of the built-in application and the OCAP application and outputted. In the case of outputting planes to the external recording equipment, a video plane, a still plane and an OSD plane are synthesized and outputted.

The plane management unit 13 manages the built-in application dedicated plane, the video plane, the still plane, and the OSD plane. The plane is pixel data for one screen stored in a memory region. The built-in application dedicated plane includes OSD information of the built-in application for one screen stored in a memory region. The video plane includes an image for one screen stored in the memory region, and the still plane includes a still image for one screen stored in a memory region, which is used as a background image by OCAP applications (52a, 52b). The OSD plane includes OSD information for one screen stored in the memory region, which is used by the OCAP application (52a, 52b). It should be noted that an OCAP application dedicated plane may further be used as a plane. This OCAP application dedicated plane includes OSD information for one screen stored in a memory region, which is not wished to be outputted to the external recording equipment by the OCAP applications (52a, 52b). It is to be noted that in this case, the OCAP application dedicated plane can be located on the uppermost surface closest to a viewpoint or between the built-in application dedicated plane and the OSD plane.

The AV decoder 14 decodes sound/image data delivered in an MPEG format or the like from the intra-station server 200. The TD decoder 15 filters a transport stream obtained by multiplexing sound data/image data. The tuner 16 receives a signal delivered by the intra-station server 200 through the cable 250. The received signal is descrambled in the cable card 300 and outputted to the TD decoder 15.

The cable card I/F 17 exchanges data with the cable card 300. The remote controller receiving unit 18 receives user's operation information from the remote controller 400, and outputs the information to the CPU 10 as a key code.

The selector 22 selects one output out of outputs from the process circuits 23a to 23c, and outputs the selected one to the synthesized unit 12. The process circuits 23a to 23c process image/sound signals input from the input system (input 1, input 2, input 3), and output the signals to the selector 22.

### <Functional Configuration of Receiving Device>

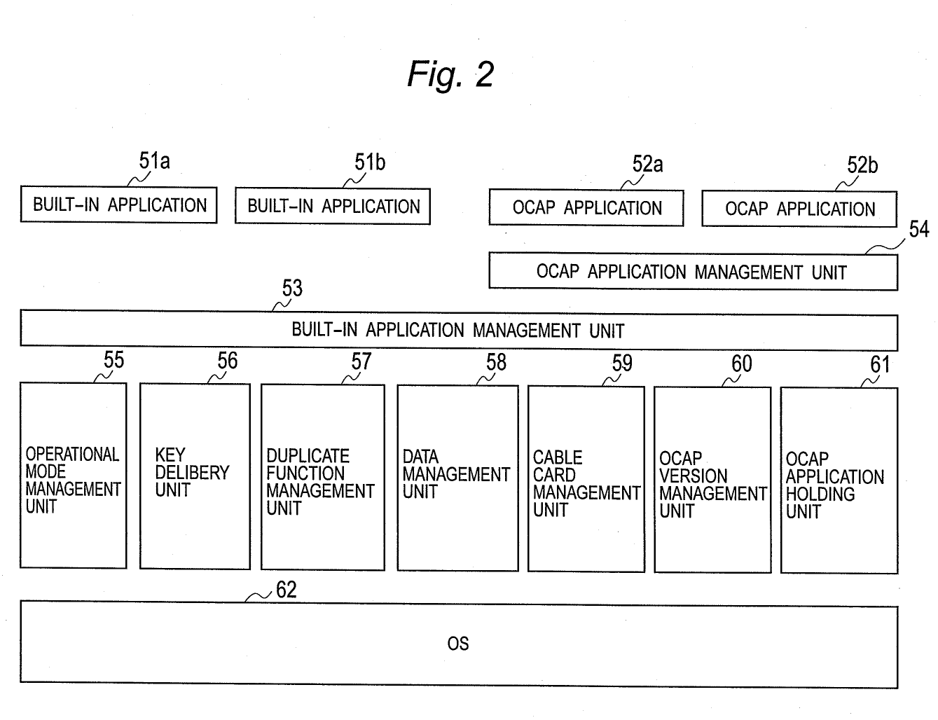

Next, a functional configuration of the receiving device 100 is described using FIG. 2. The functional configuration shown in FIG. 2 can be realized by execution of a prescribed program by the CPU 10. It should be noted that only principal functions are shown in FIG. 2 for the sake of simplicity of the explanation. It goes without saying that a later-described function of the receiving device 100, even not shown in FIG. 2, can be realized by execution of a prescribed program by the CPU 10.

The receiving device 100 is configured of the built-in applications (51a, 51b), the OCAP applications (52a, 52b), a built-in application management unit 53, an OCAP application management unit 54, an operational mode management unit 55, a key delivery unit 56, a duplicate function management unit 57, a data management unit 58, a cable card management unit 59, an OCAP version management unit 60, an OCAP application holding unit 61, and an OS 62.

The built-in applications (51a, 51b) are, for example, a channel selection application, a parental control display application, a setting application, and the like. The built-in applications (51a, 51b) are, for example, applications incorporated with shipment or installed through the network or through a storage medium such as an SD card. The OCAP applications (52a, 52b) are, for example, a channel selection application, a parental control display application, a setting application, and the like. The OCAP applications (52a, 52b) are, for example, applications acquired by downloading from the intra-station server 200.

The built-in application management unit 53 activates the built-in applications (51a, 51b), controls key delivery, and controls activation of the OCAP application management unit 54. The OCAP application management unit 54 is middleware that executes the OCAP applications (52a, 52b), and activates the OCAP applications (52a, 52b) and control key delivery.

The operational mode management unit 55 manages an operational mode of the receiving device 100. The operational mode comprises an IDTV mode and an OCAP mode: a state where only the built-in applications (51a, 51b) are in operation refers to the IDTV mode; and a state where the OCAP applications (52a, 52b) are further in operation refers to the OCAP mode. Moreover, the operational mode management unit 55 manages the states of the built-in applications (51a, 51b), and also manages activation and termination of the OCAP applications (52a, 52b) notified from the OCAP application management unit 54.

The key delivery unit 56 delivers a key code from the remote controller 400 to the built-in application management unit 53 or the OCAP application management unit 54.

The duplicate function management unit 57 determines exclusion/sharing of the built-in applications (51a, 51b) and the OCAP applications (52a, 52b) based upon the operating states of the built-in applications (51a, 51b) and the OCAP applications (52a, 52b) and previously set exclusion/sharing information. Here, the exclusion/sharing information is information describing which, OCAP or IDTV, has a priority over the other with respect to each of the same functions that are executed by both applications. A process performed by the duplicate function management unit 57 is detailed later.

The data management unit 58 manages data shared by both the built-in applications (51a, 51b) and the OCAP applications (52a, 52b), such as PIN (Personal Identification Number) information, parental information and closed-caption setting information. The cable card management unit 59 is a module that receives, manages and executes a request from the cable card 300.

The OCAP version management unit 60 manages versions of the OCAP applications (52a, 52b) held in the OCAP application holding unit 61, and also performs a version upgrade process for the OCAP applications (52a, 52b) based upon received XAIT (Extended Application Information Table). Here, XAIT is management information of the OCAP applications (52a, 52b) transmitted from the intra-station server 200 and at least includes, as information of the OCAP applications (52a, 52b) that are activated, version information and storage locations (URL information etc.) of the OCAP applications (52a, 52b). The receiving device 100 regularly receives XAIT from the intra-station server 200. The OCAP application holding unit 61 holds the OCAP applications (52a, 52b) downloaded from the intra-station server 200 based upon XAIT The OS 62 is software that manages the whole of the receiving device 100.

### <State Transition of Operation of Receiving Device>

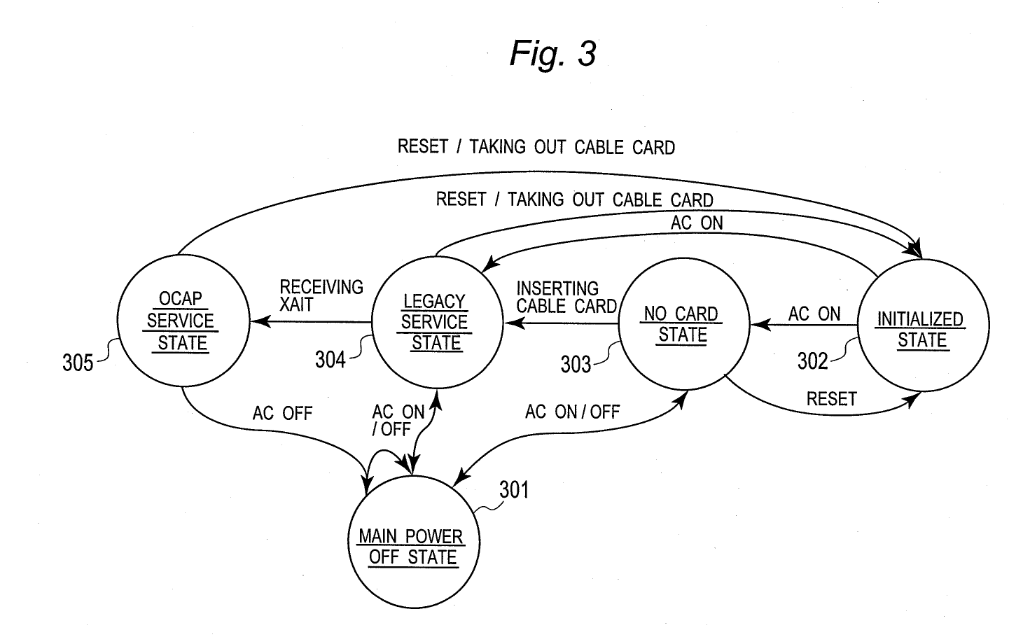

Next, state transition of the receiving device 100 upon activation of OCAP is described using FIG. 3. Here, “upon activation of OCAP” means “at the time when acquirement of Service Context defined by the OCAP standard is completed or the time when OSD is changed from an invisible state to a visible state”. It is to be noted that, other than the above, “upon activation of OCAP” may mean “at the time of completing loading of Xlet defined by the OCAP standard”, “at the time of processing int Xlet”, or “at the time of processing start Xlet”.

The receiving device 100 has five states of a main power Off state 301, an initialized state 302; a No card state 303 as a state where the cable card 300 has not been inserted; a Legacy Service state 304 as a state where the cable card 300 has been inserted and OCAP has not been activated; and an OCAP Service state 305 as a state where OCAP has been activated.

When an AC power is turned ON in the main power Off state 301, the state of the receiving device 100 transits to the No Card state 303 and the Legacy Service state 304 depending upon insertion or non-insertion of the cable card 300. When XAIT is received in the Legacy Service state 304, the state transits to the OCAP Service state 305.

### <Functional Classification of Receiving Device>

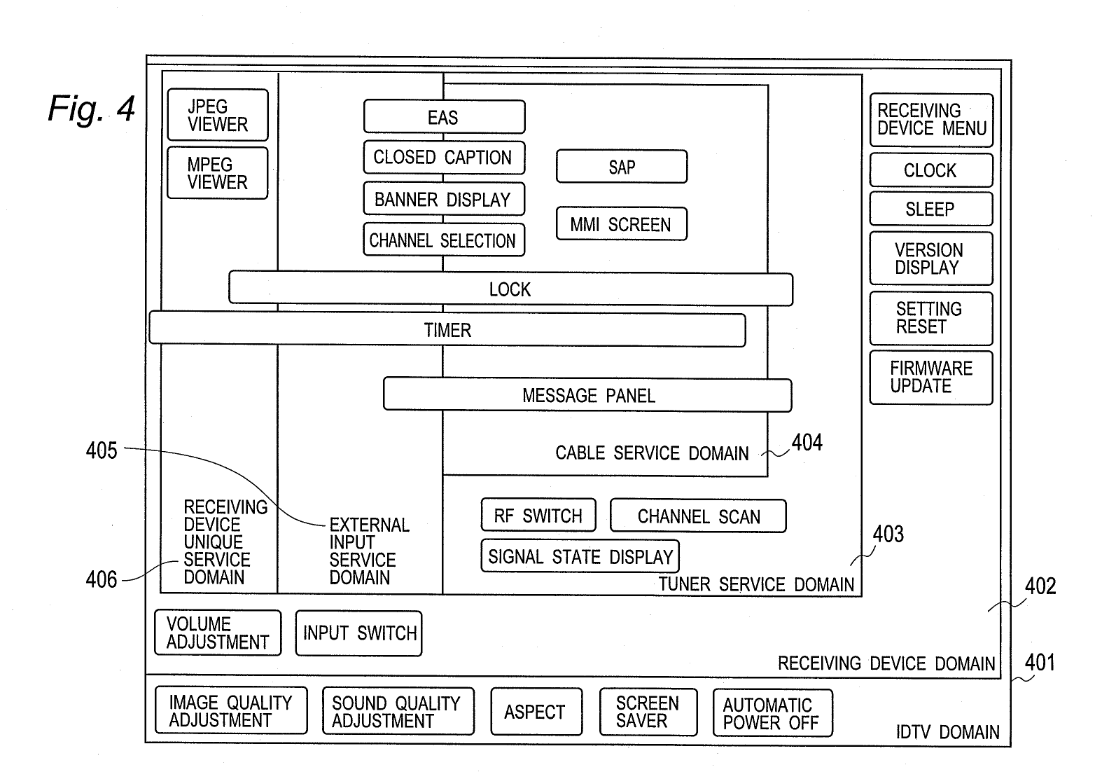

Next described using FIG. 4 is a functional classification in a case where the built-in applications (51a, 51b) and the OCAP applications (52a, 52b) are simultaneously operated in the receiving device 100.

As shown in FIG. 4, in the receiving device 100, all functions of the receiving device 100 belong to an IDTV domain 401. The IDTV domain 401 is divided into a receiving device domain 402 and others. Common functions of receiving devices such as STB and TV belong to the receiving device domain 402. Functions peculiar to TV such as a display and a speaker belong to a region not belonging to the receiving device domain 402. The receiving device domain 402 is divided into a tuner service domain 403, an external input service domain 405, a receiving device unique service domain 406, and others. A function of receiving a broadcast belongs to the tuner service domain 403. A function of providing a user with a service received from an external input belongs to the external input service domain 405. A function of providing the user with a unique service built in the receiving device belongs to the receiving device unique service domain 406. The tuner service domain 403 is divided into the cable service domain 404 and others. A function of providing the user with a service transmitted by the cable broadcast station belongs to the cable service domain 404.

There has been a problem with the receiving device 100 in that, during simultaneous operation of the built-in applications (51a, 51b) and the OCAP applications (52a, 52b), the function belonging to the cable service domain 404 is executed simultaneously in each of those applications. Thereat, in the present invention, exclusion control on the function belonging to the receiving device domain 402 is performed in between the built-in applications (51a, 51b) and the OCAP applications (52a, 52b). Hereinafter, a lock function (especially PIN input function) is described as a representative example.

First, before the exclusion control on the PIN input function is described, processes of the receiving device 100 upon activation of OCAP are described using FIG. 2.

In the case of receiving XAIT through the OS 62, the cable card management unit 59 transmits an XAIT reception notification to the built-in application management unit 53 and transmits XAIT to the OCAP version management unit 60. The built-in application management unit 53 activates the OCAP application management unit 54 upon receipt of the XAIT reception notification.

The OCAP application management unit 54 makes the OCAP version management unit 60 compare received XAIT with already stored XAIT, to activates the OCAP applications (52a, 52b) held in the OCAP application holding unit 61 based upon a result of the comparison, and also makes an OCAP activation notification to the operational mode management unit 55.

The operational mode management unit 55 sets the operational mode from the IDTV mode to the OCAP mode, and also makes the OCAP activation notification to the duplicate function management unit 57.

Upon receipt of the OCAP activation notification, the duplicate function management unit 57 acquires operating states of the built-in applications (51a, 51b) from the operational mode management unit 55. This is a series of processes upon activation of OCAP,

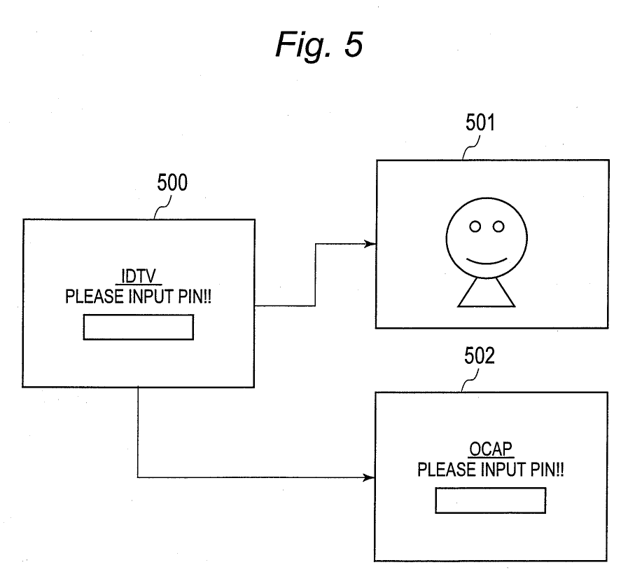

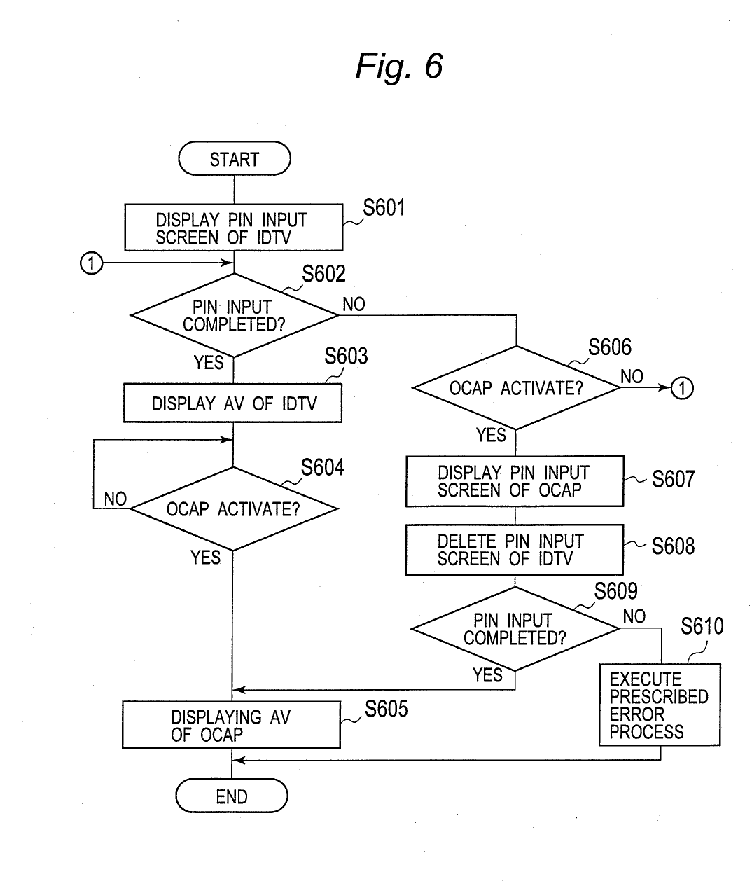

Here, the exclusion control on the PIN input function is described using FIGS. 2, 5 and 6. As for the PIN input function, the exclusion/sharing information of the duplicate function management unit 57 is “OCAP having a priority”. FIG. 5 is a view showing control of a PIN input screen upon activation of OCAP, and FIG. 6 is a flowchart showing a process regarding the exclusion control upon a PIN input.

It is assumed as a prerequisite that the receiving device 100 is in a state where a channel selection application as the built-in applications (51a, 51b) is in operation and AV is on display, and the operational mode management unit 55 holds information of the “IDTV mode” as the operational mode and “the channel selection application in operation” as the state of the built-in application.

Here, when a channel-switch key code is input from the user into the built-in application management unit 53 through the OS 62 and the key delivery unit 56, the built-in application management unit 53 delivers the channel-switch key code to the channel selection application. The channel selection application switches the channel based upon the delivered key code. It is assumed that at this time, AV after the channel switch is parentally locked. Therefore, the channel selection application transmits a request for activating a parental control display application to the built-in application management unit 53.

Upon receipt of the request for activating a parental control display application, the built-in application management unit 53 activates the parental control display application as one of the built-in applications (51a, 51b) at the front of the channel selection application (500, S601). The parental control display application then makes an activation notification to the operational mode management unit 55. The operational mode management unit 55 holds “the channel selection application in operation, PIN not reset” as the state of the built-in application.

The user makes a PIN input through the remote controller 400. PIN input information is input into the parental control display application thorough the key delivery unit 56 and the built-in application management unit 53.

After inputting of a prescribed number of letters, the parental control display application compares the PIN information managed by the data management unit 58 with the input PIN input information. When both information are consistent with each other, “PIN having been reset” is notified to the operational mode management unit 55, and also the parental control display application is terminated (YES in S602). Along with termination of the parental control display application, the user can view AV displayed by the channel selection application (S603). By this series of processes, the operational mode management unit 55 holds “the channel selection application in operation, PIN having been reset” as the state of the built-in application.

Here, it is assumed as a prerequisite that in the above state, OCAP is activated based upon the foregoing series of processes for the time of activation of OCAP and the channel selection application of OCAP is activated as the OCAP applications (52a, 52b). It is further assumed that AV displayed by the channel selection application of OCAP has been parentally locked. With activation of OCAP, the operational mode managed by the operational mode management unit 55 is the “OCAP mode”, the state of the built-in application is “the channel selection application in operation, PIN having been reset”, and the state of the OCAP application is “OCAP application in operation”. Further, the duplicate function management unit 57 acquires the respective states of the built-in application and the OCAP application from the operational mode management unit 55 (“YES” in S604).

The activated channel selection application of OCAP makes a PIN reset inquiry request to the OCAP application management unit 54. The OCAP application management unit 54 makes a PIN reset inquiry to the duplicate function management unit 57. Since holding the information of “OCAP having a priority” as the exclusion/sharing information and “PIN having been reset” as the state of the built-in application, the duplicate function management unit 57 notifies the OCAP application management unit 54 of “PIN having been reset”. Upon receipt of this, the OCAP application management unit 54 makes the response of “PIN having been reset” to the channel selection application of OCAP

By the above process, the channel selection application of OCAP prevents activation of the parental control display application of OCAP. This allows the user to display AV that is displayed by the channel selection application of OCAP without making a PIN input (501, S605).

In the above processes, upon activation of OCAP, the information of PIN having been reset of the parental control display application as the built-in applications (51a, 51b) is used (shared) by the parental control display application as the OCAP applications (52a, 52b), to perform the exclusion control upon the PIN input. However, in the above processes, a process in the case of activation of OCAP during the PIN input by the user is not mentioned. Therefore described below is the exclusion control of the PIN input screen in a case where OCAP is activated during the PIN input in the above processes.

The case is assumed where OCAP is activated based upon the foregoing series of processes upon activation of OCAP and the channel selection application of OCAP is activated as the OCAP applications (52a, 52b) in the middle of the PIN input by the user through the remote controller 400. The case is further assumed where AV displayed by the channel selection application of OCAP has been parentally locked. With activation of OCAP, the operational mode managed by the operational mode management unit 55 is the “OCAP mode”, the state of the built-in application is “the channel selection application in operation, PIN not reset”, and the state of the OCAP application is “OCAP application in operation”. Further, the duplicate function management unit 57 acquires the respective states of the built-in application and the OCAP application from the operational mode management unit 55 (“NO” in S602, “YES” in S606).

The activated channel selection application of OCAP makes a PIN reset inquiry request to the OCAP application management unit 54. The OCAP application management unit 54 makes a PIN reset inquiry to the duplicate function management unit 57. Since holding “OCAP having a priority” as the exclusion/sharing information and the information of “PIN not reset” as the state of the built-in application, the duplicate function management unit 57 notifies the OCAP application management unit 54 of “PIN not reset”. The OCAP application management unit 54 makes the response of “PIN not reset” to the channel selection application of OCAP.

Upon receipt of this, the channel selection application of OCAP transmits to the OCAP application management unit 54 a request for activation of the parental control display application. Upon receipt of the request for activation of the parental control display application, the OCAP application management unit 54 activates the parental control display application as one of the OCAP applications (52a, 52b) at the front of the channel selection application (502, S607). The activated parental control display application of OCAP makes a during-PIN-input notification to the duplicate function management unit 57.

Upon receipt of the during-PIN-input notification, the duplicate function management unit 57 transmits to the built-in application management unit 53 a request for termination of the parental control display application. The built-in application management unit 53 terminates the parental control display application of the built-in application on display (S608). The parental control display application notifies the operational mode management unit 55 of “PIN not reset” upon its termination.

By the above process, after performing a normal PIN input process by OCAP (“YES in S609), the user can view AV that is displayed by the channel selection application of OCAP (S605).

In accordance with the above-mentioned manner, in a condition where the built-in applications (51a, 51b) and the OCAP applications (52a, 52b) simultaneously operate the PIN input function, it is possible to efficiently make an adjustment between the applications.

It is to be noted that, although the PIN input function was described as the representative example in present first embodiment, also as for functions simultaneously operated in both applications, such as a banner display function and a channel selection related display function (e.g. tuning error display function), when the OCAP application is activated, an application relevant to the banner display function, the channel selection related display function (e.g. tuning error display function) or the like, which is in operation as the built-in applications (51a, 51b), is terminated.

### Second Embodiment

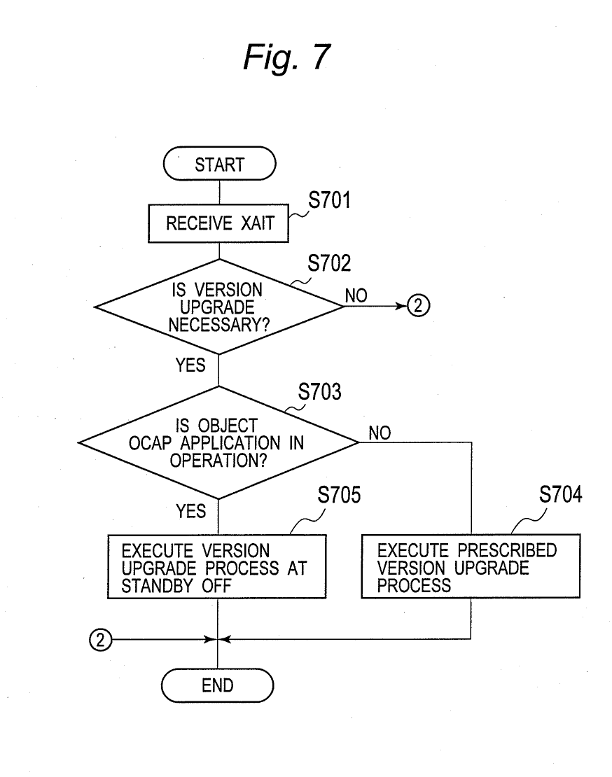

In present second embodiment, a comparison process in the OCAP version management unit 60 is detailed. Particularly from the view point of version upgrade of the OCAP applications (52a, 52b), a description is given using FIGS. 2 and 7. It is to be noted that there are a case where the version upgrade is performed upon activation of OCAP and a case where XAIT is received during operation of OCAP and the upgrade is performed based upon that receipt. In both cases, there is no change in that a trigger is a reception of XAIT Thereat, in second embodiment of the present invention, the case where XAIT which notifies the version upgrade is received during operation of OCAP, is described as an example.

When receiving XAIT through the OS 62, the cable card management unit 59 transmits XAIT to the OCAP version management unit 60 (S701).

The OCAP version management unit 60 having received XAIT at least acquires identifiers and version information of the OCAP applications (52a, 52b) currently in activation from the OCAP application management unit 54. The OCAP version management unit 60 then determines whether or not the version upgrade is necessary based upon the information acquired from the OCAP application management unit 54, received XAIT and the versions of the OCAP applications (52a, 52b) which are held in the OCAP application holding unit 61 (702). When it is determined that the version upgrade is necessary (“YES” in S702) and when the OCAP applications (52a, 52b) as the objects for the version upgrade are not in operation (“NO” in Step S703), the OCAP applications (52a, 52b) are acquired by a prescribed method from storage locations described in received XAIT and the object OCAP applications (52a, 52b) in the OCAP application holding unit 61 are rewritten (S704).

On the other hand, in a case where the OCAP applications (52a, 52b) as the objects for the version upgrade are in operation (“YES in S703), a prescribed version upgrade process is not executed until the receiving device 100 comes into a standby-off state. Here, the standby-off state is notified to the built-in application management unit 53 as a key code through the OS 62 and the key delivery unit 56 by the user's operation of the remote controller 400 or a button or the like installed on the receiving device 100. When detecting the standby-off, the built-in application management unit 53 transmits a standby-off notification to the OCAP application management unit 54. Upon receipt of this standby-off notification, the OCAP application management unit 54 makes a standby-off notification to the OCAP version management unit 60. By this series of processes, the OCAP version management unit 60 detects the standby-off state and acquires the OCAP applications (52a, 52b) by a prescribed method from storage locations described in received XAIT, and the object OCAP applications (52a, 52b) in the OCAP application holding unit 61 are rewritten. After completion of rewriting, the OCAP version management unit 60 makes a rewriting completion notification to the OCAP application management unit 54, and upon receipt of the rewriting completion notification, the OCAP application management unit 54 is reactivated (S705).

It is to be noted that, although the OCAP application management unit 54 is reactivated upon receipt of the rewriting completion notification in the process of Step S705 in present second embodiment, only the OCAP applications (52a, 52b) in activation as the objects for the version upgrade may be reactivated.

Further, although the trigger for the standby-off notification is the operation of the remote controller 400 or the operation of the button installed on the receiving device 100 as the user's direct operation, the trigger may be an internal event.

By the above process, the version upgrade of the OCAP applications (52a, 52b) can be efficiently performed.

### Third Embodiment

A description of a receiving device in common in each of the following embodiments is given regarding: (1) a hardware configuration of the receiving device; (2) a functional configuration (software configuration) of the receiving device; (3) a transition state of operation of the receiving device; (4) functional classification of the receiving device; (5) definition of terms; and (6) correspondence of each constitutional element in the claims to each unit in the embodiments.

(1) Hardware Configuration of Receiving Device

The hardware configuration according to third embodiment of the present invention is substantially the same as the hardware configuration of the receiving device 100 according to the first embodiment shown in FIG. 1, and its description is thus omitted.

(2) Functional Configuration of Receiving Device

Next, the functional configuration of the receiving device 100 is described using FIG. 2. The functional configuration shown in FIG. 2 is realized by execution of a prescribed program by the CPU 10 and the foregoing hardware configuration of the receiving device 100. It is to be noted that only principal functions are shown in FIG. 2 for the sake of convenience of the description. It goes without saying that a later-described function of the receiving device 100, even a function not shown in FIG. 2, can be realized by execution of a prescribed program by the CPU 10.

It should be noted that the functional configuration of the receiving device 100 according to third embodiment may include the substantially identical functional configuration to the functional configuration of the receiving device according to first embodiment. A description is omitted as for this case of the identical functional configuration to the functional configuration of the receiving device according to first embodiment.

(3) Transition State of Operation of Receiving Device

Next, FIG. 3 is a view for explaining state transition of the receiving device 100 upon activation of OCAP. It is to be noted that this state transition of the receiving device 100 upon activation of OCAP is also substantially the same as in the case of the receiving device according to first embodiment and its description is thus omitted.

(4) Functional Classification of Receiving Device

Next, FIG. 4 is a view for explaining a functional classification of a case where the built-in applications (51a, 51b) and the OCAP applications (52a, 52b) are simultaneously operated in the receiving device 100. It should be noted that the functional classification in the case where both applications are simultaneously operated in the receiving device 100 is also substantially the same as in the case of the receiving device according to First embodiment, and its description is thus omitted.

(5) Definition of Terms

The setting information is information for setting an output of an input image signal (including image and sound signals, an image or sound signal, data information and the like other than image and sound signals), and specifically a language selection information for setting in which language, English, Japanese, or the like, an input image signal is outputted, a closed-caption information for the hearing impaired included in the input image signal, SAP information for selecting either the main sound or the sub sound for an image single to be outputted, and some other information.

“Upon activation” means “at the time when acquirement of Service Context defined by the OCAP standard is completed” or “at the time when OSD is changed from an invisible state to a visible state”. It is to be noted that, other than the above, “upon activation of OCAP” can also mean “at the time of completing loading of Xlet defined by the OCAP standard”, “at the time of processing int Xlet”, or at the time of processing start Xlet”.

“During operation” refers to “in an operating state after the time of activation” in the OCAP application, and for example, when “Upon activation” is defined as any of “at the time of completing loading of Xlet”, “at the time of processing int Xlet” and “at the time of processing start Xlet”, “upon operation” means “at the time when acquirement of Service Context defined by the OCAP standard is completed” or “at the time when OSD is changed from an invisible state to a visible state”.

(6) Correspondence of Each Constitutional Element in Claims to Each Unit in the Embodiments

In the following, examples of correspondence of each constitutional element in the claims to each unit in the embodiments are described, but the present invention is not restricted to the following examples.

The OCAP application 52a and the OCAP application 52b which were described in the foregoing embodiments correspond to the first application received from the broadcast station, the built-in application 51a and the built-in application 51b correspond to the second application previously stored into the receiving device, the OCAP application management unit 54 corresponds to the first application management unit, and the built-in application management unit 53 corresponds to the second application management unit.

Further, the remote controller 400 described in the foregoing embodiment corresponds to the event input unit, the user's operation information corresponds to the event, the duplicate function management unit 57 corresponds to the duplicate management unit, and the operational mode management unit 55 corresponds to the operation management unit.

Based upon the configuration as above, the present invention is described in more detail.

There are cases in the receiving device 100 where, when the built-in applications (51a, 51b) and the OCAP applications (52a, 52b) are simultaneously operated, a function belonging to the cable service domain 404 may be simultaneously executed in each application. In the present invention, as for functions belonging to the receiving device domain 402, data is shared between the built-in applications (51a, 51b) and the OCAP applications (52a, 52b). In the following, data sharing between the built-in applications (51a, 51b) and the OCAP applications (52a, 52b) is detailed. It is to be noted that in the following description, the case of closed-caption information for the hearing impaired, which is included in an input image signal, is described as an example of data sharing. In addition, the present invention is not restricted to the closed-caption information, but the setting information may be any setting information for setting an output of an image or a sound other than the closed-caption information.

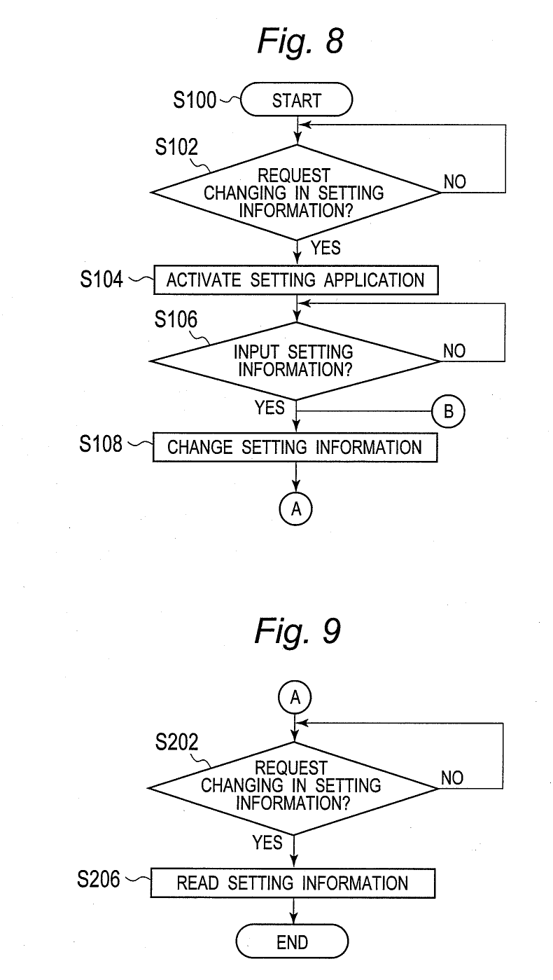

In the following, a process for data sharing during operation of the OCAP applications (52a, 52b) is described with reference to FIG. 8. First described is the state of the receiving device 100 at the starting point of the process for data sharing during operation of the OCAP applications (52a, 52b) in FIG. 8.

At the starting point (S100) of the process for data sharing during operation of the OCAP applications (52a, 52b) in FIG. 8, the state is an OCAP Service state 305. In the state transition diagram of the receiving device 100 shown in FIG. 3, the AC power is turned ON in the main power Off state 301, and through the No Card state 303 depending upon insertion or non-insertion of the cable card 300, the state transits to the Legacy Service state 304 and thereafter, XAIT is received in the Legacy Service state 304 and the state becomes the OCAP Service state 305.

Further, in the functional constitutional view of the receiving device 100 shown in FIG. 2, in the built-in applications (51a, 52a), for example, the channel selection application for channel selection is in operation, and also in the OCAP applications (52a, 52b), for example, the channel selection application for channel selection is in operation. Moreover, these built-in applications (51a, 52a) are activated by the built-in application management unit 53, and the OCAP applications (52a, 52b) are activated and the operations thereof are managed by the OCAP application management unit

Further, in the operational mode management unit 55, the operational mode has been set from the IDTV mode to the OCAP mode, and the information of “the channel selection application in operation” is stored as the state of the built-in application, and the information of “the channel selection application in operation” is stored as the state of the OCAP application. Moreover, in the data management unit 58, the currently set setting information is stored. For example, information of the current closed-caption setting being OFF, and the like, is stored. It should be noted that, although the state of the channel selection application is determined in the operational mode management unit 55 in the foregoing description, it is also possible to previously decide, without specifically acquiring a state of OCAP applications that when one application has been started, that one application is the channel selection application, so as to acquire the state where the OCAP applications being the channel selection application in operation.

In such a condition, with reference to the hardware constitutional view of the receiving device 100 of FIG. 1, the functional constitutional view of the receiving device 100 of FIG. 2, and the flowcharts of FIGS. 8 and 9, the process for sharing data sharing information between the built-in applications (51a, 51b) and the OCAP applications (52a, 52b) associated with a change in setting information.

The receiving device 100 determines whether or not a key input (event input) regarding a change in setting information has been made from the remote controller 400 through the remote controller receiving unit 18 (S102). Here, the key input regarding a change in setting information is a signal for requesting activation of the setting application. Specifically, the receiving device 100 determines whether or not a key input input from the remote controller 400 has been made into the remote controller receiving unit 18.

Next, when determining in S102 that the key input has been made, the receiving device 100 acquires information of the current operational mode from the operational mode management unit 55, and the application management unit currently in operation activates a setting application (S104). More specifically, since the current operational mode is the OCAP mode in the operational mode management unit 55 as described above, a key input regarding a change in this setting information is notified to the OCAP application management unit 54 through the key delivery unit 56. In response to this notification, the OCAP application management unit 54 activates a setting application as one of the OCAP applications (52a, 52b), and notifies this operating state to the operational mode management unit 55. Thereby, the operational mode of the operational mode management unit 55 at this time point shows the “OCAP application”, and the state of the OCAP application is “the channel selection application and the setting application” in operation, and that of the built-in application is “the channel selection application” in activation.

It is to be noted that in the foregoing description, the configuration was described where the operational mode in the operational mode management unit 55 is determined and a key input is delivered from the key delivery unit 56 to either the built-in application management unit 53 or the OCAP application management unit 54. In the present invention, as another means to be realized, such a configuration can also be formed where it is previously decided in the remote controller 400 to which, the built-in application management unit 53 or the OCAP application management unit 54, the key input is to be transmitted, and the key delivery unit 56 having received the key input delivers the key input to the built-in application management unit 53 or the OCAP application management unit 54 which was previously selected in the remote controller 400. In this case, when previously making a key input into the remote controller 400, the user can select into which, the built-in application management unit 53 or the OCAP application management unit 54, the key input is to be made.

Next, it is determined whether or not an input regarding setting information has been made (S106). Specifically, closed-caption setting information stored in the data management unit 58 is read and outputted onto the screen by the setting application, and it is determined whether or not the content outputted onto the screen has been changed and a decision has been made by the user using the remote controller 400, whereby it is determined whether or not the closed-caption setting has been changed. For example, as described above, the state of “the closed caption=OFF” has been set in the current data management unit 58, and when the state of “the closed caption=ON” is selected by the key input made this time, it is determined that the input regarding setting information has been made.

Here, when the input regarding setting information is made in S106, in the data management unit 58, this content set in the setting application is set in a closed-caption region referenced by both the built-in application management unit 53 and the OCAP application management unit 54.

On a stage where the above process is terminated, the setting application is terminated. Simultaneously with the termination of the setting application, the user becomes able to view an image signal displayed by the channel selection application in the foregoing state of “the closed caption=ON”.

Subsequently, with reference to the flowchart of FIG. 9, data sharing in the built-in application management unit 53 is described. It is assumed here that the above state has been changed from the OCAP Service state in FIG. 3 to the Legacy Service state.

Further, in the operational mode management unit 55, the operational mode has been set from the OCAP mode to the IDTV mode, and the information of “the channel selection in operation” is stored as the state of the built-in application, and the information of “the channel selection application in operation” is stored as the state of the OCAP application. Further, in the data management unit 58, setting information which is currently set is stored. For example, the information of the current closed-caption setting being ON, or the like, is stored.

First, the receiving device 100 determines whether or not the application has been changed to the built-in applications (51a, 51b) (S202). Specifically, in the operational mode management unit 55, it is determined whether or not the operational mode has been set from the OCAP mode to the IDTV mode.

Next, when it is determined that the application has been set to the built-in applications (51a, 51b), the built-in application management unit 53 activates a closed-caption setting application as one of the built-in applications. By this closed-caption setting application, the closed-option setting information is set to the setting information set into the data management unit 58 by the foregoing setting application (S206). Specifically the closed-caption setting application acquires the information of the closed-caption setting in the data management unit 58 having been turned ON by the channel selection application, and turns ON the closed-caption setting in the built-in applications (51a, 51b).

On a stage where the above process is terminated, the closed-caption setting application is terminated. Simultaneously with the termination of the closed-caption setting application, the user becomes able to view an image signal displayed by the channel selection application in the foregoing state of “the closed caption=ON”.

This allows the user to carry the closed-caption setting, once made using the setting application as one of the OCAP applications (52a, 52b), to the closed-caption setting application as one of the built-in applications (51a, 51b), so as to eliminate the need for the user to duplicately make the closed-caption setting and allow prevention of the user from being complicated.

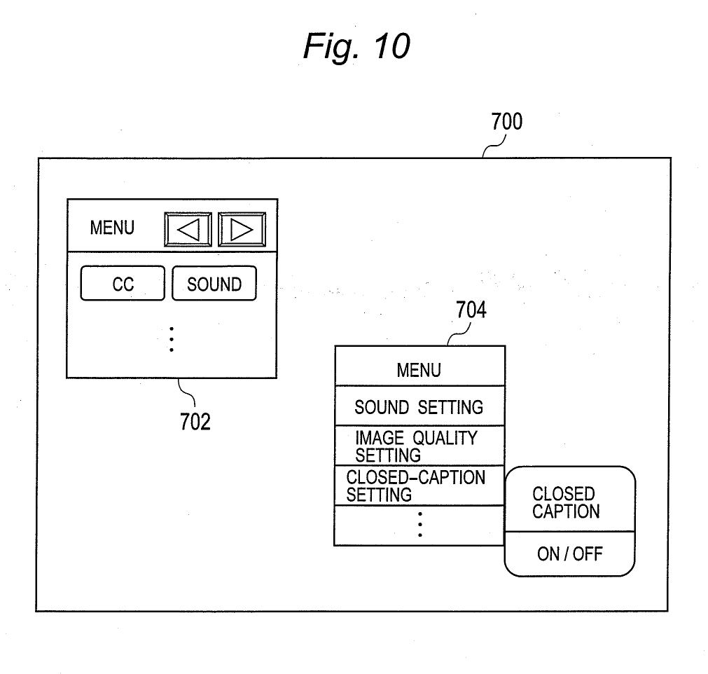

It is to be noted that, although the case was described where the operational mode is changed from the OCAP mode to the IDTV mode in the foregoing state, the present invention is not restricted to this, and for example, as shown in FIG. 10, data sharing is also possible in the same manner even in a state where the built-in applications (51a, 51b) and the OCAP applications (52a, 52b) are held in simultaneous activation. Specifically, in FIG. 10, a setting application 702 as the OCAP applications (52a, 52b) and a closed-caption setting application 704 as the built-in applications (51a, 51b), described above, are in simultaneous operation with respect to a television screen 700, and in such a state, the content set in the setting application 702 can be data-shared by the closed-caption setting application 704. In this case, data sharing can be realized such that the duplicate function management unit 57 notifies the closed-caption setting application 704 as the built-in applications (51a, 51b) of the change in data in the data management unit 58.

Moreover, although the case was described in the foregoing embodiment where both the built-in applications (51a, 51b) and the OCAP applications (52a, 52b) are in operation, the present invention is not restricted to this, and for example, data sharing can be conducted even in a case where setting information is changed through the closed-caption setting application 704 when only the built-in applications (51a, 51b) are in activation and even in a case where the OCAP applications (52a, 52b) are activated thereafter.

It is to be noted that, although the example was described in the foregoing embodiment where the setting information set by the OCAP applications (52a, 52b) is reflected to the built-in applications (51a, 51b), the present invention is not restricted to this, and for example, setting information set by the built-in applications (51a, 51b) can also be reflected to the OCAP applications (52a, 52b).

### Fourth Embodiment

In third embodiment described was that sharing (data sharing) of a change in setting information between the built-in applications (51a, 51b) and the OCAP applications (52a, 52b) eliminates the need for the user to duplicately change the setting information. However, a defect may occur if data sharing is conducted between the built-in applications (51a, 51b) and the OCAP applications (52a, 52b) in every case.

For example, in a case where a parental function of setting a program not suitable for youth not to be viewed has been set in each of the built-in applications (51a, 51b) and the OCAP applications (52a, 52b), and the parental function in either the built-in applications (51a, 51b) or the OCAP applications (52a, 52b) is reset, when the parental function in the other is also reset together due to data sharing of the resetting, the application not intended to be reset by the user is also reset together, and thereby the program not suitable for youth is brought into a viewable state.

Thereat, in the present invention, the data management unit 58 has a first region which stores a setting information accessed in common by the built-in applications (51a, 51b) and the OCAP application 52b, and a second region which stores a setting information accessed independently and differently by the built-in applications (51a, 51b) and the OCAP applications (52a, 52b). When a key input is made to set the setting information in the application currently in activation to its initial state, the whole or part of the first region which stores the setting information accessed in common by the built-in applications (51a, 51b) and the OCAP applications (52a, 52b) is reset. Further, the whole or part of the setting information in the application currently in activation in the second region which stores the setting information accessed independently and differently by the built-in applications (51a, 51b) and the OCAP applications (52a, 52b) is reset.

According to the present invention, even in the case of changing the setting information to its initial state as described above, it is not necessary to reset the setting information in each of the built-in applications (51a, 51b) and the OCAP applications (52a, 52b). Meanwhile, as for the setting information that cannot be data-shared can be reset in each of the built-in applications (51a, 51b) and the OCAP applications (52a, 52b).

In the following described as an example is a process in a case where a key input for setting the setting information, stored in the built-in application management unit 53, to its initial state (resetting) is made by the user through the remote controller 400.

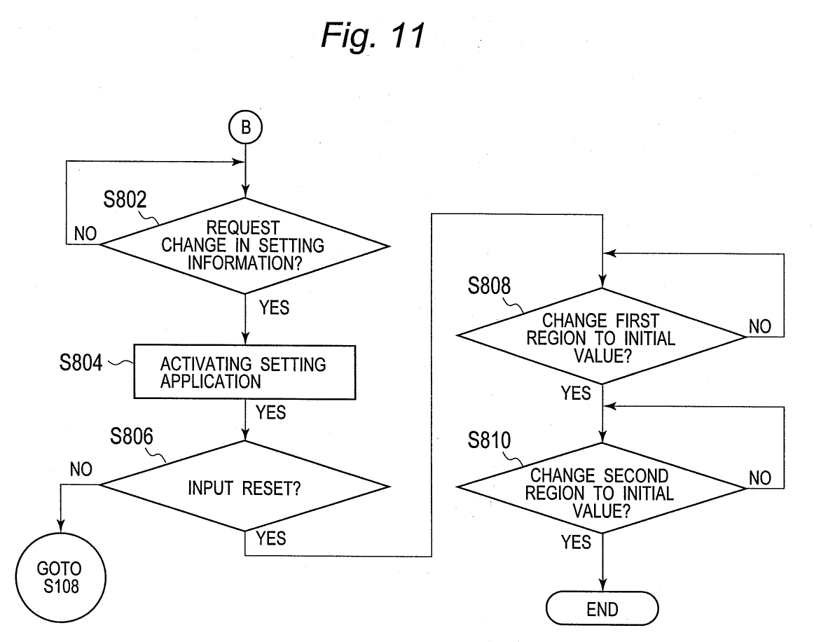

It should be noted that the in this fourth embodiment, the closed caption set by the user through the remote controller 400 in third embodiment is described as an example, but the present invention is not restricted to this, and any setting information for setting an output of an image or a sound other than this may be applied. In the following, a change in setting information to its initial state in the present invention is described with reference to FIG. 11. Further, FIG. 11 is explanation of processes after S106 of FIG. 8. It is assumed here that a key input for resetting is made by the user through the remote controller 400 in S106 of FIG. 8.

The receiving device 100 determines whether or not a key input regarding resetting (resetting) has been made from the remote controller 400 through the remote controller receiving unit 18 (S802). Here, the key input regarding resetting is a signal requesting activation of an application for changing the setting information in the application currently in activation to its initial state. Further, even in the case of not activating an application, the key input may be a signal requesting a change in setting information in the setting application.

Next, when determining in S802 that the key input regarding resetting has been made, the receiving device 100 acquires information of the current operational mode from the operational mode management unit 55, and the application management unit currently in operation activates the setting application (S804). More specifically, since the current operational mode is the OCAP mode in the operational mode management unit 55 as described above, the key input regarding a change in the setting information is notified to the OCAP application management unit 54 through the key delivery unit 56.

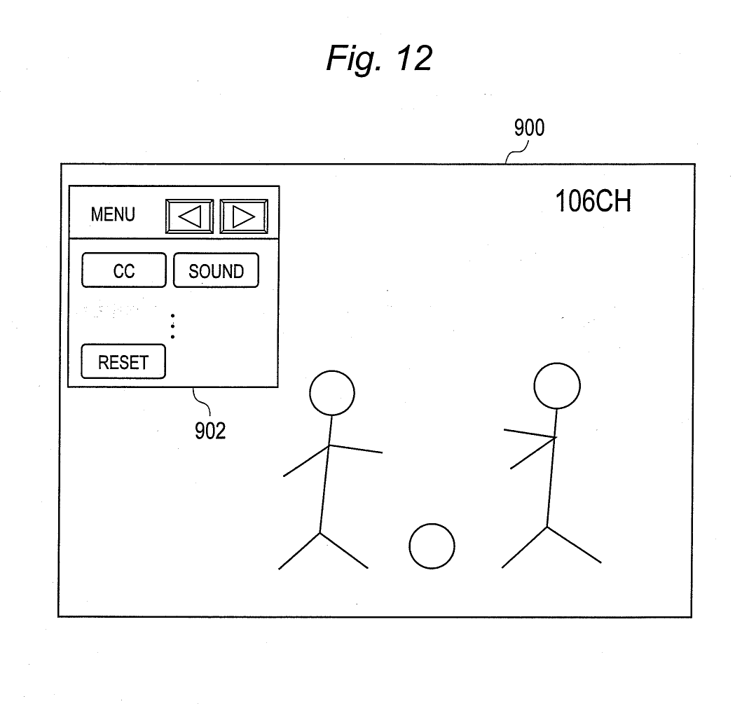

In response to this notification, as shown in FIG. 12, the OCAP application management unit 54 activates the setting application (902 in FIG. 12) as one of the OCAP applications (52a, 52b), and notifies this operating state to the operational mode management unit 55. Thereby, at this time point, the operational mode of the operational mode management unit 55 indicates the “OCAP application”, the state of the OCAP applications (52a, 52b) is “the channel selection application and the setting application” in operation, and the state of the built-in applications (51a, 51b) is “the channel selection application” in activation.

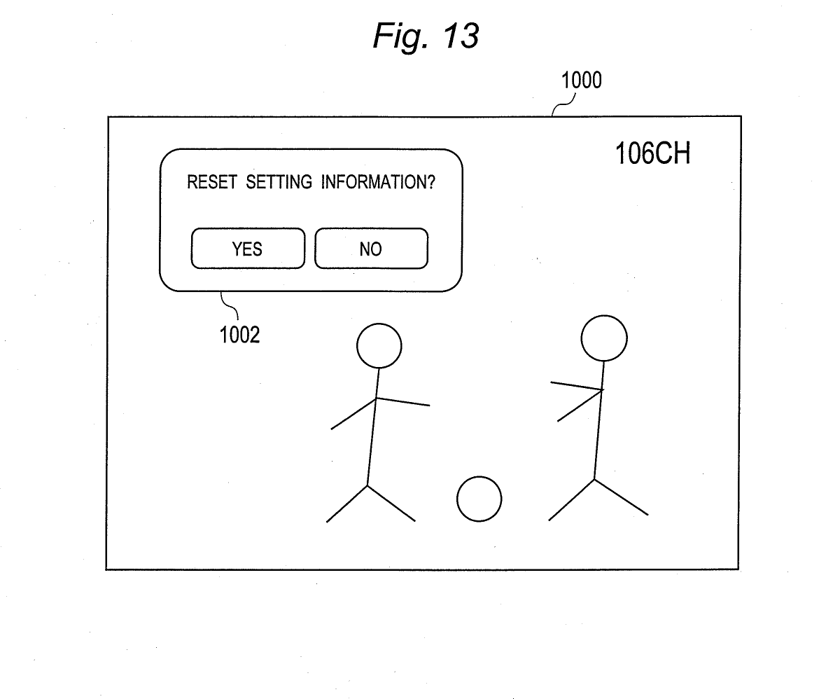

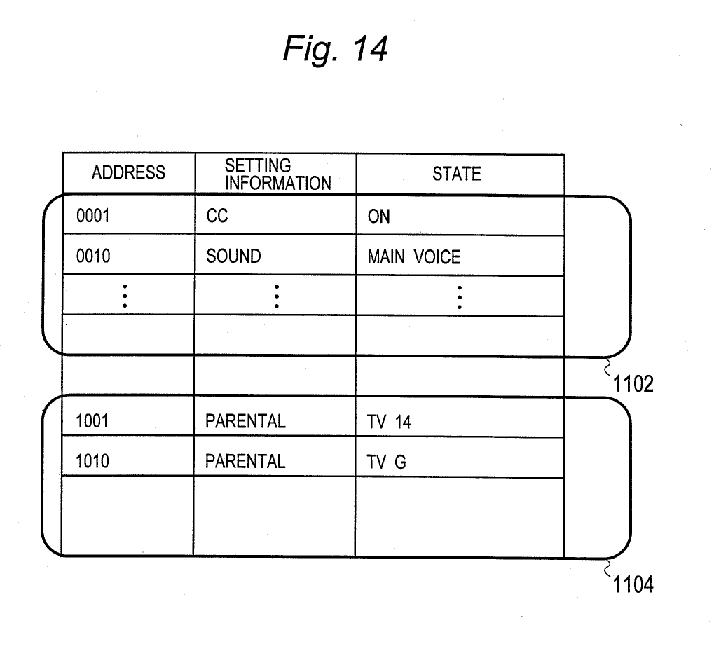

It is to be noted that, although the setting application as one of the OCAP applications was activated in response to the key input for resetting in this fourth embodiment, the present invention is not restricted to this, and as shown in FIG. 13, it is also possible to activate a resetting application dedicated to resetting (numeral 1002 in FIG. 13) as one of the OCAP applications.

Further, in the foregoing description, the configuration was described where the operational mode in the operational mode management unit 55 is determined and the key input for resetting is delivered from the key delivery unit 56 to either the built-in application management unit 53 or the OCAP application management unit 54. In the present invention, as another means to be realized, such a configuration can also be formed where it is previously decided in the remote controller 400 to which, the built-in application management unit 53 or the OCAP application management unit 54, the key input for resetting is to be transmitted and the key delivery unit 56 having received the key input delivers the key input to the built-in application management unit 53 or the OCAP application management unit 54 which was previously selected in the remote controller 400. In this case, when previously making a key input into the remote controller 400, the user can select into which, the built-in application management unit 53 or the OCAP application management unit 54, the key input is to be made.

Next, it is determined whether or not a key input for executing resetting regarding the setting information has been made (S806). Specifically, as a first method, as shown in FIG. 12, the setting application 902 is outputted onto the screen, and it is determined whether or not resetting has been decided by the user using the remote controller 400, thereby to determine whether or not a key input for resetting the setting information has been made. Further, as a second method, as shown in FIG. 13, the resetting application 1002 is outputted onto the screen and it is determined whether or not resetting has been decided by the user using the remote controller 400, thereby to determine whether or not the key input for resetting the setting information has been made.

Next, when the key input for resetting has been made in S806, the OCAP application notifies the data management unit 58 of selling of an initial value through the OCAP application management unit 54, whereby in the data management unit 58, changes are made in contents of the setting information in the first region which stores the setting information accessed in common by both the built-in applications (51a, 51b) and the OCAP applications (52a, 52b) and in the second region which stores the setting information separately accessed by each of the applications in the second region (S808, S810).

Here, this first region refers to a region 1102 shown in FIG. 14. When the content described in this region is reset by either the built-in applications (51a, 51b) or the OCAP applications (52a, 52b), the setting information in the data management unit 58 is set to its initial state. Therefore, in the foregoing example, as described in third embodiment, the closed-caption setting is changed from the ON state to the OFF state since having been in the OFF state in its initial state.

Further, the second region refers to a region 1104 shown in FIG. 14. When the content described in this second region is key input for resetting by either the built-in applications (51a, 51b) or the OCAP applications (52a, 52b), only setting information in the corresponding application is set to its initial state. Therefore, in the foregoing example, only setting information, described in an address 1001 relevant to the OCAP applications (52a, 52b) currently in operation is changed out of the parental control described in FIG. 14, and the setting information described in an address 1010 as the same parental control is the setting information relevant to the built-in applications (51a, 51b) and is thus not reset.

With the configuration as thus described, in the receiving device 100 of the present invention, a change in the setting information is shared (data-shared) between the built-in applications (51a, 51b) and the OCAP applications (52a, 52b), which eliminates the need for the user to duplicately change the setting information. Further, preventing data sharing more than necessary can dissolve a defect of the user that occurs due to data sharing.

It should be noted that although the case of resetting was described in this fourth embodiment, the present invention is not restricted to this, and it is also possible to perform the same process on a key input by the user other than resetting.

Further, it is also possible to previously select by the user as to the setting information in which, the first region or the second region, is to be stored with respect to each content of the setting information. It is thereby possible to conduct data sharing in accordance with user's preference.

Moreover, as shown in FIG. 10, it is also possible to perform the data resetting process in the same manner even in a state where the built-in applications (51a, 51b) and the OCAP applications (52a, 52b) are held in simultaneous activation. Specifically, in FIG. 10, the setting application 702 as the OCAP applications (52a, 52b) and the foregoing closed-caption setting application 704 as the built-in applications (51a, 51b) are in simultaneous operation with respect to the television screen 700, and in such a state, the content set in the setting application 702 can also be reflected to the closed-caption setting application 704. In this case, data sharing can be realized such that the duplicate function management unit 57 notifies the closed-caption setting application 704 as the built-in applications (51a, 51b) of the change in setting information in the first region of the data management unit 58.

Moreover, although the example was described in the foregoing embodiment where the key input for resetting set by the OCAP applications (52a, 52b) is reflected to the built-in applications (51a, 51b), the present invention is not restricted to this, and for example, the key input for resetting set by the built-in applications (51a, 51b) can also be reflected to the OCAP applications (52a, 52b).

### Fifth Embodiment

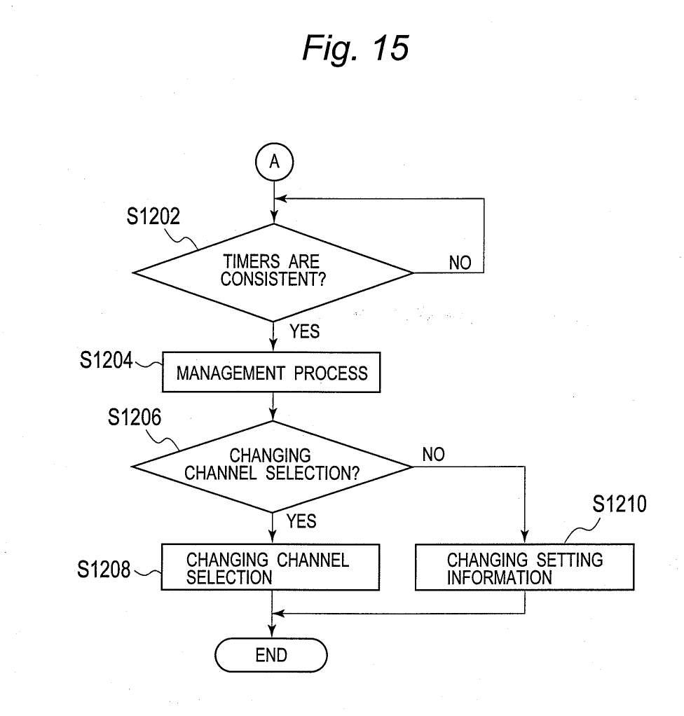

In third embodiment described was that with respect to the setting information set in either the built-in applications (51a, 51b) or the OCAP applications (52a, 52b), sharing (data sharing) of a change in the setting information between the built-in applications (51a, 51b) and the OCAP applications (52a, 52b) eliminates the need for the user to duplicately change the setting information. In this fifth embodiment, an example is described where management is made between the built-in applications (51a, 51b) and the OCAP applications (52a, 52b) in response to a key input set in either the built-in applications (51a, 51b) or the OCAP applications (52a, 52b). In this fifth embodiment, a Timer On function is described as an example. This Timer On function refers to a function of starting a channel selection for a prescribed service at prescribed time even when the user is currently viewing a service, and automatically changing the service from the one currently viewed by the user to the newly channel-selected service. It is to be noted that although the Timer On function is described in the present embodiment, the present invention is not restricted to this. In the following, a process of the Timer On function is described with reference to FIG. 15. Here, FIG. 15 shows a flowchart of a management process of the Timer On function.

At the starting point (S1200) of the management process during operation of the OCAP applications in FIG. 15, in the state transition diagram for the receiving device 100 shown in FIG. 3, the AC power is turned ON in the main power Off state 301, and through the No Card state 303 depending upon insertion or non-insertion of the cable card 300, the state transits to the Legacy Service state 304 and thereafter, XAIT is received in the Legacy Service state 304 and the state becomes the OCAP Service state 305.

Further, in the functional constitutional view of the receiving device 100 shown in FIG. 2, in the built-in applications (51a, 52a), for example, the channel selection application for channel selection is in operation, and also in the OCAP applications (52a, 52b), for example, the channel selection application for channel selection is in operation. Moreover these built-in applications (51a, 52a) are activated by the built-in application management unit 53, and the OCAP applications (52a, 52b) are activated by the OCAP application management unit 54, and the operations thereof are managed.

Further, in the operational mode management unit 55, the operational mode has been set from the IDTV mode to the OCAP mode, and the information of “the channel selection application in operation” is stored as the state of the built-in application, and the information of “the channel selection application in operation” is stored as the state of the OCAP application. Moreover, into the duplicate function management unit 57, a channel selection information is stored that a key input for starting the channel selection for a prescribed service by the built-in applications (51a, 51b) at prescribed time was made. It should be noted that since a process for storing the channel selection information into the duplicate function management unit 57 is a process having been conventionally generally performed, its description is omitted.

In such a condition, with reference to the hardware constitutional view of the receiving device 100 of FIG. 1, the functional constitutional view of the receiving device 100 of FIG. 2, and the flowcharts of FIG. 15, the management process between the built-in applications (51a, 51b) and the OCAP applications (52a, 52b) is described.

The receiving device 100 compares the time information of the channel selection information stored in the duplicate function management unit 57 with time information in a timer of the receiving device 100, thought not shown, to determine whether or not the information are consistent with each other (S1202). Specifically, for example, when the channel selection information of selecting 6 ch at 9 p.m. is stored, this is compared with the current time of the timer of the receiving device 100, to determine whether or not the time has reached 9.p.m.

Next, when determining in S1202 that the times are consistent with each other, the receiving device 100 performs management between the currently viewed service and the service channel-selected based upon channel selection information. Specifically, while the OCAP applications (52a, 52b) are currently in operation, the built-in applications (51a, 51b) are interrupted through the built-in application management unit 53, and the duplicate function management unit 57 manages as to which, a service channel-selected by the OCAP applications (52a, 52b) or a service channel-selected by the built-in applications (51a, 51b) based upon the channel selection information, is to be outputted onto the screen.

It is to be noted that as a reference to perform this management, priority information of the built-in applications (51a, 51b) and the OCAP applications (52a, 52b) can be previously provided into the data management unit 58, and the duplicate function management unit 57 can perform management based upon the priority stored into the data management unit 58.

Further, as a reference to perform another management, operational modes of the built-in applications (51a, 51b) and the OCAP applications (52a, 52b) (e.g. the OCAP application being in the VOD (Video On Demand) state, etc.) can be acquired from the operational mode management unit 55, to perform management based upon the operating states thereof.

Next, in S1204, the receiving device 100 notifies the operational mode management unit 55 of a management result as to which, the built-in applications (51a, 51b) or the OCAP applications (52a, 52b), was selected by the duplicate function management unit 57. Upon receipt of this management result, the receiving device 100 determines whether or not to change a channel selection (S1206).

When determining to change the channel selection, namely in the foregoing example, the operational mode is changed from the OCAP applications (52a, 52b) to the built-in applications (51a, 51b), and based upon channel selection information set by the built-in applications (51a, 51b), 6 ch at 9 p.m. is selected. It should be noted that in this case, the duplicate function management unit 57 notifies the OCAP applications (52a, 52b) through the OCAP application management unit 54 that the channel selection has been changed to 6 ch.

On the other hand, when it is determined not to change the channel selection, namely when it is determined not to change the operational mode from the OCAP applications (52a, 52b) to the built-in applications (51a, 51b) in the foregoing example, the channel selection is continuously made in the currently viewed OCAP applications (52a, 52b).

With the configuration as thus described, in the present invention, even when duplicate operations are performed by the built-in applications (51a, 51b) and the OCAP applications (52a, 52b), selecting either application make both applications have an effect on each other in resource control between the built-in applications (51a, 51b) and the OCAP applications (52a, 52b), thereby it is possible to prevent a defect in operating the receiving device.

It is to be noted that, although the example was described where management between the built-in applications (51a, 51b) and the OCAP applications (52a, 52b) is performed based upon the channel selection information set by the built-in applications (51a, 51b) in the foregoing embodiment, the present invention is not restricted to this, and for example, management may be reflected to the built-in applications (51a, 51b) based upon the channel selection information set by the OCAP applications (52a, 52b).

The receiving device according to the present invention is a receiving device for receiving broadcast data, and is useful as a broadcast receiving device such as TV and STB where functions are realized by both the built-in application and the downloaded application.

Further, the receiving device according to the present invention can be used as a receiving device for parallelly processing the OCAP application received from the broadcast station and the built-in application previously stored into the receiving device.

Although the present invention was described in detail in the preferred embodiments as described above, the present invention is not restricted to these, and it would be obvious for the skilled in the art that there can be the number of preferred modified examples and corrected examples within the technical scope of the present invention recited in the following claims.

What is claimed is:

1. A receiving device, capable of processing a first application received from a broadcast station and a previously built-in second application, comprising:
a first application management unit operable to control the first application;
a second application management unit operable to control the second application;
an operation management unit operable to hold operating states of the first application and the second application; and
a duplicate function management unit operable to hold exclusion/sharing information showing priorities of the first application and the second application, and operable to make the first application management unit or the second application management unit perform an exclusion control based upon the exclusion/sharing information or the operating state managed by the operation management unit, and
wherein the duplicate function management unit terminates the second application in activation, upon activation of the first application.

2. A receiving device, capable of processing a first application received from a broadcast station and a previously built-in second application, comprising:
a first application management unit operable to control the first application;
a second application management unit operable to control the second application;
an operation management unit operable to hold operating states of the first application and the second application; and
a duplicate function management unit operable to hold exclusion/sharing information showing priorities of the first application and the second application, and operable to make the first application management unit or the second application management unit perform an exclusion control based upon the exclusion/sharing information or the operating state managed by the operation management unit, and
wherein the first application prevents an activation of a third application relevant to the first application based upon a result of the exclusion control by the duplicate function management unit.

3. The receiving device according to claim 1, wherein the first application transmits a prescribed inquiry request to the first application management unit upon activation, and
wherein the first application management unit acquires information on the prescribed inquiry request from the duplicate function management unit, and notifies the first application of the acquired information as a response to the prescribed inquiry request.

4. The receiving device according to claim 2, wherein the first application transmits a prescribed inquiry request to the first application management unit upon activation, and
wherein the first application management unit acquires information on the prescribed inquiry request from the duplicate function management unit, and notifies the first application of the acquired information as a response to the prescribed inquiry request.

5. The receiving device according to claim 3, wherein the first application activates a third application relevant to the first application upon receipt of the response to the prescribed inquiry request, and
wherein the third application makes a prescribed notification to the duplicate function management unit upon activation, and upon receipt of the prescribed notification, the duplicate function management unit makes the second application management unit terminate the second application.

6. The receiving device according to claim 4, wherein the first application prevents an activation of a third application relevant to the first application upon receipt of the response to the prescribed inquiry request.

7. The receiving device according to claim 5, wherein the second application and the third application are applications having the same function.

8. The receiving device according to claim 7, wherein the same function is a PIN input function.

9. The receiving device according to claim 1, wherein the second application is an application relevant to at least a banner display and a tuning error display.

10. A receiving device, capable of processing a first application received from a broadcast station and a previously built-in second application, comprising:
a cable card management unit operable to receive at least version information of the first application and a storage location of the first application;
an application holding unit operable to hold the first application;
a first application management unit operable to hold information of the first application in activation;
a second application management unit operable to control the second application, and also operable to detect a standby-off state; and
a version management unit operable to hold the version information of the first application held by the application holding unit, and also operable to control version upgrade of the first application, and
wherein the version management unit determines whether or not version upgrade is necessary based upon the version information acquired from the cable card management unit, the information of the first application in activation which was acquired from the first application management unit, and the held version information, and in the case of determining that version upgrade of the first application in activation is necessary, the version management unit makes the cable card management unit receive a latest first application from the storage location based upon a standby-off notification from the second application management unit, to rewrite the first application in the application holding unit to the latest first application.

11. The receiving device according to claim 10, wherein the version management unit makes a rewriting completion notification to the first application management unit after rewriting the first application in the application holding unit to the latest first application, and
wherein the first application management unit is reactivated based upon the rewriting completion notification.

12. A receiving device, capable of processing a first application received from a broadcast station and a second application previously stored into the receiving device, comprising:
a first application management unit operable to control the first application;
a second application management unit operable to control the second application;
a data management unit operable to store a setting information for setting outputs of an image or a sound of the first application management unit and the second application management unit; and
an event input unit operable to input an event, wherein the setting information stored in the data management unit is rewritten when the setting information stored in the data management unit is changed by the event input unit during activation of the first or second application.

13. A receiving device, capable of processing a first application received from a broadcast station and a second application previously stored into the receiving device, comprising:
a first application management unit operable to control the first application;
a second application management unit operable to control the second application;
a data management unit operable to store a setting information for setting outputs of an image or a sound of the first application management unit and the second application management unit; and
an event input unit operable to input an event, wherein the first or second application management unit in activation activates a third application for setting the setting information and the setting information in the data management unit is rewritten by the third application when an event concerning the setting information is input by the event input unit during activation of the first or second application.

14. A receiving device, capable of processing a first application received from a broadcast station and a second application previously stored into the receiving device, comprising:
a first application management unit operable to control the first application;
a second application management unit operable to control the second application;
a data management unit operable to store a setting information for setting outputs of an image or a sound of the first application management unit and the second application management unit; and
an event input unit operable to input an event, wherein the first or second application in activation outputs an image or a sound based upon the setting information in the data management unit, in which the setting information has been changed, when the setting information stored in the data management unit is changed by the event input unit upon activation of either the first or second application.

15. The receiving device according to claim 14, further comprising a duplicate management unit operable to determine sharing or non-sharing of control information by the first application management unit and the second application management unit, and
wherein the first or second application management unit in activation notifies the duplicate management unit of a change in control information when the setting information stored in the data management unit is changed by the event input unit during activation of either the first or second application, and
wherein the first or second application management unit inquires of the duplicate management unit about whether or not to change the control information upon activation of either the first or second application.

16. The receiving device according to claim 12, wherein the data management unit has a first region which stores a setting information accessed in common by the first application management unit and the second application management unit, and a second region which stores a setting information different between the first application management unit and the second application management unit, and
wherein the setting information only in the whole or part of the first region and only in the whole or part of a region in the second region which stores the setting information of the application currently in activation are set to initial states when an event of setting the setting information of the application currently in activation to initial states is input by the event input unit.

17. The receiving device according to claim 12, wherein the setting information at least includes any of language setting, sound setting, closed-caption setting, and favorite channel selection.

18. A receiving device, capable of processing a first application received from a broadcast station and a second application previously stored into the receiving device, comprising:
a first application management unit operable to control the first application;
a second application management unit operable to control the second application;
a duplicate management unit operable to manage interruption of the other application during operation of either the first or second application;
an operation management unit operable to store an operating state of the first or the second application; and
an event input unit operable to input an event, wherein the duplicate management unit manages as to which, the first or second applications, is to be outputted and transmits a result of the management to the operation management unit when an event of starting a channel selection for a prescribed service at prescribed time in the first or second application is input by the event input unit.

19. A receiving device, capable of processing a first application received from a broadcast station and a second application previously stored into the receiving device, comprising:
a first application management unit operable to control the first application;
a second application management unit operable to control the second application;
a data management unit operable to store a setting information for setting outputs of an image or a sound of the first application management unit and the second application management unit; and
an event input unit operable to input an event, and
wherein the data management unit stores a priority of an image signal outputted from the first or second application, and
wherein the receiving device comprises a duplicate management unit which determines whether or not to perform a channel selection for a prescribed service, input by the event input unit, based upon the priority stored in the data management unit when an event of starting the channel selection for a prescribed service at prescribed time in the first or second application is input by the event input unit.

20. A receiving device, capable of processing a first application received from a broadcast station and a second application previously stored into the receiving device, comprising:
a first application management unit operable to control the first application;
a second application management unit operable to control the second application;
a data management unit operable to store a setting information for setting outputs of an image or a sound of the first application management unit and the second application management unit;
an event input unit operable to input an event; and
an operation management unit operable to manage an operating state of the first or second application, and
wherein the receiving device comprises a duplicate management unit which determines whether or not to perform a channel selection for a prescribed service, input by the event input unit, based upon the current operating state by the operation management unit when an event of starting the channel selection for a prescribed service at prescribed time in the first or second application is input by the event input unit.
